(19) United States
(12) Patent Application Publication
(10) Pub. No.: US 2004/0053596 A1
(43) Pub. Date: Mar. 18, 2004

(54) Radio receiver

(76) Inventors: Lars Svensson, Goteborg (SE); Bengt Lindoff, Bjarred (SE)

Correspondence Address: JENKENS & GILCHRIST, PC, 1445 ROSS AVENUE, SUITE 3200, DALLAS, TX, 75202, US

(21) Appl. No.: 10/250,829

(22) PCT Filed: Jan. 7, 2002
(86) PCT No.: PCT/EP02/00067

(30) Foreign Application Priority Data
Jan. 9, 2001 (GB) 0100538.8

(51) Int. Cl. H04B 1/00; H04B 1/10; H04B 1/26; H04B 15/00

(52) U.S. Cl. 455/324; 455/130; 455/313; 455/318; 455/311; 455/295

(57) ABSTRACT

In a radio receiver, clock distribution changes, that is, enabling or disabling the clock signals to specific circuit blocks at specific times to reduce power consumption, can cause changes in the DC offset level. Knowledge about clock distribution changes can be used to improve receiver performance. Specifically, information about clock distribution changes is stored during signal reception, and used to predict the presence of DC offset step changes.

### TECHNICAL FIELD OF THE INVENTION

This invention relates to a radio transceiver, and in particular to a homodyne radio receiver for use in a communication system, such as a cellular radio telephone system.

### BACKGROUND OF THE INVENTION

In a transmitter of a digital radio communications system, information bits are mapped to waveforms that modulate a carrier signal. In the receiver, the transmitted sequence of bits is retrieved by demodulation of the received signal.

A generally efficient design of receiver circuit is the direct conversion, or homodyne, radio receiver, in which the received carrier signal is directly downconverted to baseband, without use of any intermediate frequencies. This architecture can be efficient in terms of cost, size and current consumption.

Since the bandwidth of the demodulated signal extends down to DC, one problem which can arise in a direct conversion receiver is distortion due to a DC offset. DC offset can arise in the baseband or radio parts of the transmitter, or, more commonly, in the baseband or radio parts of the receiver circuit.

The DC offset signal can in fact be several dB larger than the magnitude of the information signal. It is thus apparent that the DC offset must be removed before the data can be satisfactorily recovered.

U.S. Pat. No. 5,584,059 discloses a radio receiver in which the DC offset is successively approximated, allowing it to be compensated for. This technique can be successful, provided that the level of the DC offset is constant, or varies only slowly.

However, the level of the DC offset can change suddenly, and the prior art technique is not well able to compensate for such changes.

One source of step changes in the level of the DC offset is changes in the clock distribution in the receiver.

An important consideration in the design of equipment such as portable or handheld mobile communications devices is the power consumption thereof. It is clearly desirable to minimise the power consumption. One way in which this is achieved, in synchronous digital receivers realised in CMOS in particular, is to design the circuit in blocks, and to disable the clock signal to any block which is not at present active. When the clock signal to a block is disabled, no storage element outputs a changed value, and no transitions propagate into the logic. Most importantly, only a small leakage current is drawn from the power supply.

However, a disadvantage of this approach is that harmonics of clock signals may be coupled strongly enough to the receiver input to affect the DC output level, after mixing. Constant or slowly varying effects can be compensated for, but, when a clock signal is disabled or enabled, there can be a step change in that DC output level. When different clock signals to different blocks are frequently disabled and enabled to save power, this can produce frequent step changes in the DC level.

### SUMMARY OF THE INVENTION

According to the invention, knowledge about clock distribution changes in a digital subsystem is used to improve the performance of a radio frequency circuit.

The radio frequency circuit may most advantageously be a radio receiver, but could be a radio transmitter.

Specifically, according to one aspect of the invention, in a radio receiver, information about clock distribution changes is stored during signal reception, and used to improve the quality of signal demodulation. For example, the information can be used to predict the presence of DC offset step changes.

According to another aspect of the invention, information about the magnitudes of DC steps caused by different clock distribution changes is stored, information is stored about clock distribution changes occurring during signal reception, and the stored information used to predict the presence of DC offset step changes.

Preferably, the stored information about the magnitudes of DC steps caused by different clock distribution changes is adaptively maintained.

### BRIEF DESCRIPTION OF DRAWINGS

FIG. 1 is a block schematic diagram of a radio receiver in accordance with the invention.

FIG. 2 is a representation of a part of the receiver of FIG. 1, illustrating the effect of clock distribution changes;

FIG. 3 shows a time history of a signal within the receiver of FIG. 1.

### DETAILED DESCRIPTION OF PREFERRED EMBODIMENTS

As described herein, the invention relates to the use of knowledge about the presence, and the effects, of clock distribution changes in a radio frequency circuit. The radio frequency circuit may be a radio receiver, or may be a radio transmitter, for example. By way of a more specific example, one embodiment of the invention will now be described in detail.

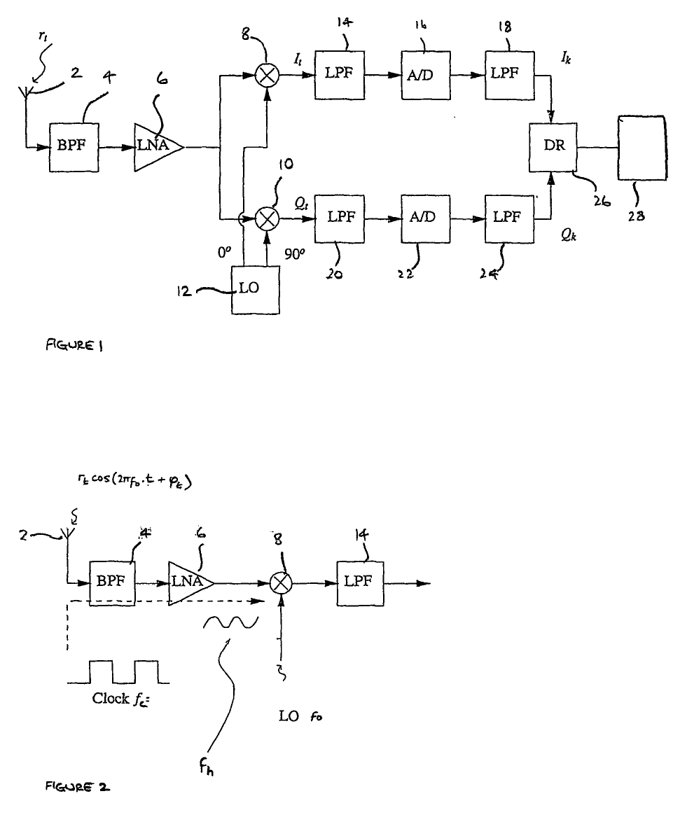

FIG. 1 shows the architecture of a typical direct conversion radio receiver. An antenna receives radio frequency signals rₜ, and feeds them to a band-pass filter 4 and a low noise amplifier 6. The amplified signals are split and passed to first and second in-phase and quadrature mixers 8, 10, which also receive in-phase and quadrature signals from a local oscillator 12. The downconverted in-phase signals Iₜ are then supplied to a low pass filter 14, analog-digital converter 16, and further low pass filter 18, to produce an in-phase digital sample stream Iₖ, while the downconverted quadrature signals Qₜ are supplied to a low pass filter 20, analog-digital converter 22, and further low pass filter 24, to produce a quadrature digital sample stream Qₖ. The digital sample streams are then supplied to a data recovery unit 26. The data recovery unit 26 typically includes a synchronization unit, for finding time alignment of the received signal burst, a channel estimator, for estimating the radio channel characteristics, and an equalizer, uses the estimated radio channel characteristics to obtain the required data symbols from the received data sample streams.

The digital parts of the receiver, such as the low-pass filters 18, 24 and the data recovery unit 26, are preferably implemented in CMOS, and different blocks are supplied with clock signals. For example, FIG. 1 shows the components of the receiver which are used to demodulate data signals from a received analog signal. However, a device incorporating the receiver may for example be a mobile phone or other communications device. It will be apparent to the person skilled in the art that such a device will necessarily include other elements. For example, a mobile phone will include, amongst other things, functional blocks such as a speech coder, and a speech decoder. Implementations of these and other blocks will include elements such as buffer memories and bus interfaces.

By way of an illustration, FIG. 1 shows a speech decoder 28 connected to the digital signal processor 26, to receive the demodulated digital sample streams, and to decode speech signals from amongst them.

In order to minimise power consumption of the device, the clock signal to any block may be disabled when that block is not active, and then enabled again when the block is to be active.

For example, on the functional level, the clock to a speech coder can be disabled when there is no speech to be encoded and transmitted, a clock to a speech decoder can be disabled when no encoded speech is being received. On the implementation level, a clock to a bus interface can be disabled when there is no traffic on the relevant bus, and a clock to a buffer memory can be disabled when the memory is not being accessed.

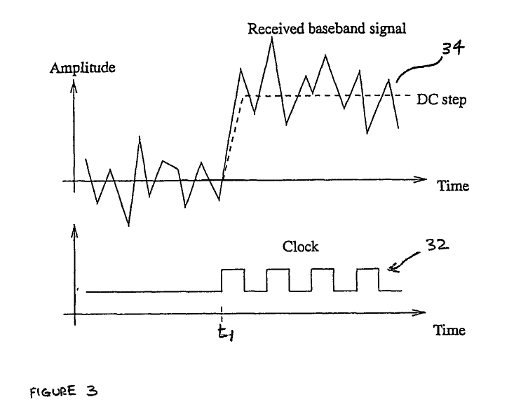

FIG. 2 shows a part of the receiver of FIG. 1, and one way in which a clock signal in one block of the device can affect signals passed through the receiver.

Thus, FIG. 2 shows a signal rₜ cos(2πf₀.t+φₜ), thus having a centre frequency f₀, being received at the antenna 2, being passed to the filter 4 and amplifier 6, and then to a mixer 8, where it is mixed with a local oscillator signal at the same frequency f₀.

At the same time, a clock signal at frequency f_{c} is applied to another block within the device. A part of that clock signal leaks into the radio receiver circuitry, for example through the antenna port. Since the clock signal is a square wave, it includes components at harmonic frequencies, that is, at multiples of f_{c} Any harmonic fₕ=n.f_{c} (where n is an integer), which is within the pass-band of the filter 4, will reach the input of the mixer 8. If, moreover, the difference frequency (fₕ−f₀) is within the pass band of the filter 14, the harmonic will influence the signal being A-D converted, to the detriment of the reception quality.

The undesired signal may appear as a slowly varying DC signal (with frequency fₕ−f₀) at the output of the filter 14.

FIG. 3 illustrates this effect. A clock signal 32 to a particular block is enabled at time t₁. Before time t₁, the received baseband signal 34 has an approximately zero average amplitude. However, it can be seen that the effect of enabling the clock is to produce a step change in the level of the DC offset. It is to be understood that DC offset variations at the difference frequency (fₕ−f₀) are slow enough not to be discernable in this figure.

The effect on the DC offset level of disabling and enabling the clock signals, that is, changing the clock distribution, is known. Moreover, the receiver will know when clock distribution changes are to occur.

Thus, the receiver can store information about the occurrence of clock distribution changes, and can use this information to predict step changes in the DC offset level at those times.

Further, different clock distribution changes will produce different effects. For example, disabling the clock signal to a bus interface may produce a different magnitude change in the DC level from disabling the clock signal to a speech coder. This information can be stored, and information about the effects of clock distribution changes which actually occur can be used to predict step changes in the DC offset level at those times. For example, this information can be stored during manufacture of the receiver.

Alternatively, or additionally, actual effects of different clock distribution changes can be monitored in use of the receiver, and used to update the stored information about those effects. For example, the levels of clock signal leakage into a mobile phone antenna port may depend on whether a user is holding the antenna.

Such adaptive maintenance of predictions of DC level changes allows the receiver to predict more accurately the effects of clock distribution changes when these are slowly varying.

When the effects of clock distribution changes can be predicted, they can be used to provide compensation for the resulting step changes in the DC level, at least to a first order.

Further, knowledge about the effects of clock distribution changes can also be used for other purposes. For example, changes in the DC offset level of a demodulated signal can occur as a result of internally generated disturbances, such as clock distribution changes as discussed above, or as a result of externally generated disturbances, such as changes in the quality of the transmission link.

A radio receiver typically includes an equalizer, as mentioned above with reference to FIG. 1, which compensates for changes in the channel quality.

In accordance with the invention, internally generated changes in the DC offset level of the demodulated signal, such as those caused by clock distribution changes, can be taken into consideration when decoding the signal.

For example, knowledge about internally generated changes in the DC offset level can be used to prevent these from affecting the channel estimator in the data recovery unit 26. This allows the equalizer tap values to be optimized for the channel, and therefore improves signal demodulation.

As another example of the use of knowledge about DC offset level changes, received signal bursts typically include one or more checksum bits, which allow the receiver to detect whether the received burst includes one or more bit errors. Based on the expected DC offset level at any time, the receiver can determine a degree of uncertainty, or “soft value”, associated with any detected signal. Thus, when a checksum value indicates that one bit within a burst contains an error, it is more likely to be a bit with a bad “soft value” than a bit with a good “soft value” that contains the error. A higher DC offset level at any time can be used to calculate a worse “soft value” in respect of bits received at that time.

Moreover, internally generated changes in the DC offset level of the demodulated signal, such as those caused by clock distribution changes, can be disregarded when making assessments of channel quality, for example when making handoff decisions in a mobile communications system.

Thus, as the above example makes clear, the invention allows the receiver to compensate for at least some internally generated steps in the DC offset value.

In the same way, a clock signal in a block of a device including a radio frequency transmitter can leak through into the RF circuits, and can cause steps in the DC offset levels there. Signal levels are generally higher in transmitters than in receivers, so such changes are less likely to cause problems, but nevertheless the present invention allows for such changes to be taken into consideration.

For example, a DC offset generated in this way might cause a tone to be generated at the transmitter carrier frequency, while will then be transmitted with the desired modulated signal. The tone will then be downconverted to a DC offset in the receiver. If knowledge is available about changes in clock distribution within the transmitter, and hence about the resulting DC offset changes which may produce this unwanted tone, a compensation signal can be introduced. For example, a DC compensation signal can be added to the I and Q baseband signals in the digital parts of the transmitter to cancel the known DC offset changes.

The transmitted signal then contains only the desired modulated signal.

There is thus described a radio frequency device, and a method of operation thereof, which allows information about changes in clock distributions to be used.

1. A method of controlling a radio frequency device, comprising:
storing information about clock distribution changes in the device, and
controlling signal processing within the device based on the stored information.

2. A method as claimed in claim 1, wherein the device is a radio receiver.

3. A method of controlling a direct conversion radio receiver, comprising:
storing information about clock distribution changes during signal reception, and using the stored information to predict the presence of DC offset step changes.

4. A method as claimed in claim 3, comprising:
storing information about DC offset step changes caused by specific clock distribution changes.

5. A method as claimed in claim 3, comprising:
measuring DC offset step changes caused by specific clock distribution changes; and
updating the stored information based on the measured values.

6. A method as claimed in claim 3, wherein:
information about predicted DC offset step changes is used to compensate for said changes.

7. A method of controlling a direct conversion radio receiver, comprising:
storing information about clock distribution changes during signal reception, and using the stored information to distinguish between DC offset step changes caused by clock distribution changes and externally generated DC offset step changes.

8. A method as claimed in claim 7, further comprising using information distinguishing between DC offset step changes caused by clock distribution changes and externally generated DC offset step changes in processing received signals.

9. A radio frequency device, comprising:
a controller for storing information about clock distribution changes in the device, and for controlling signal processing within the device based on the stored information.

10. A device as claimed in claim 9, wherein the device is a radio receiver.

11. A direct conversion radio receiver, comprising:
a controller for storing information about clock distribution changes during signal reception, and for using the stored information to predict the presence of DC offset step changes.

12. A radio receiver as claimed in claim 11, wherein the controller is adapted to store information about DC offset step changes caused by specific clock distribution changes.

13. A radio receiver as claimed in claim 11, wherein the controller is adapted to measure DC offset step changes caused by specific clock distribution changes, and update the stored information based on the measured values.

14. A radio receiver as claimed in claim 11, wherein the controller is adapted to use information about predicted DC offset step changes to compensate for said changes.

15. A direct conversion radio receiver, comprising a controller adapted to store information about clock distribution changes during signal reception, and to use the stored information to distinguish between DC offset step changes caused by clock distribution changes and externally generated DC offset step changes.

16. A radio receiver as claimed in claim 15, wherein the controller is further adapted to use information distinguishing between DC offset step changes caused by clock distribution changes and externally generated DC offset step changes in processing received signals.

17. A radio receiver, comprising:
digital circuitry;
means for enabling or disabling clock signals to the digital circuitry; and
a controller for storing information about clock distribution changes, and for controlling signal processing within the receiver based on the stored information.

18. A radio receiver as claimed in claim 17, comprising a controller for compensating for DC offset step changes caused by clock distribution changes.

19. A radio receiver as claimed in claim 17, comprising a controller for controlling equaliser soft values based on the stored information.

20. A portable radiocommunications device, including a radio frequency device as claimed in claim 9 or 10.

21. A portable radiocommunications device, including a radio receiver as claimed in one of claims 11-19.
